(19) United States
(12) Patent Application Publication
(10) Pub. No.: US 2023/0155137 A1
(43) Pub. Date: May 18, 2023

(54) COMPOSITE ELECTRODE FOR FLOW CELL, FLOW CELL, AND PILE

(71) Applicants: CHINA ENERGY INVESTMENT CORPORATION LIMITED, Beijing (CN); NATIONAL INSTITUTE OF CLEAN-AND-LOW CARBON ENERGY, Beijing (CN)

(72) Inventors: Yongsheng FAN, Beijing (CN); Qinghua LIU, Beijing (CN); Ping MIAO, Beijing (CN)

(73) Assignees: CHINA ENERGY INVESTMENT CORPORATION LIMITED, Beijing (CN); NATIONAL INSTITUTE OF CLEAN-AND-LOW CARBON ENERGY, Beijing (CN)

(21) Appl. No.: 17/917,994

(22) PCT Filed: Mar. 18, 2021
(86) PCT No.: PCT/CN2021/081419

§ 371 Date: Oct. 10, 2022

(30) Foreign Application Priority Data
Apr. 10, 2020 (CN) 202010281604.3

(51) Int. Cl. H01M 4/86; H01M 4/96

(52) U.S. Cl. CPC H01M 4/8657; H01M 4/8605; H01M 4/96; H01M 4/8647

(57) ABSTRACT

The present invention relates to the technical field of energy storage. Disclosed in the invention are a composite electrode for a flow cell, a flow cell, and a stack. The composite electrode comprises: a distribution layer, used to distribute an electrolyte; a reaction layer used to receive the electrolyte of the distribution layer and provide an electrochemical reaction site for the electrolyte; and a contact layer, used to reduce the contact resistance of the distribution layer so as to reduce an internal resistance of the flow cell. In the present invention, by means of providing a distribution layer, a reaction layer and a contact layer, an electrochemical reaction site and an electrolyte distribution site of a composite electrode can be effectively separated, the distribution layer being able to greatly reduce dead zones and channeling caused by uneven flow distribution, and the contact layer being able to greatly reduce the internal resistance of the flow cell. Meanwhile, the distribution layer and the reaction layer can be separately and specially designed, thus improving the output power and energy efficiency of a cell or a stack taking the present composite electrode as an anode and/or a cathode.

### CROSS-REFERENCE TO RELATED APPLICATION

The present application claims priority to Chinese Patent Application 202010281604.3 filed on Apr. 10, 2020, and the contents of which are incorporated herein by reference.

### TECHNICAL FIELD

The present invention relates to the technical field of energy storage, and particularly to a composite electrode for a flow cell, a flow cell and a stack.

### BACKGROUND OF THE INVENTION

As a key technology to improve an energy utilization rate, energy storage can improve a utilization rate of renewable energy and a stability of a power grid, and is mainly used for grid connection of renewable energy, peak load shifting, peak load and frequency regulation, and the like. Flow cell has become one of main technologies for large-scale energy storage due to the advantages of long service life, safety and reliability, independent design of power and capacity, and the like.

The flow battery is generally composed of a power unit and a capacity unit. As the capacity unit, electrolyte can store and release energy by changing a valence state of an active substance. The electrolyte flows through an interior of a stack used as the power unit during operation, and carries out conversion of electric energy and chemical energy, thus realizing the input and output of power. Therefore, on the premise that an electrolyte system is determined, a performance of the stack determines the working ability and efficiency of an energy storage system.

Specifically, the electrolyte flows through the interior of the stack, and reacts electrochemically on a surface of the electrode, so as to realize conversion of chemical energy and electric energy. In this process, flow distribution of the electrolyte, concentration polarization, contact resistance between the electrode and a bipolar plate, and other factors all have great influences on the electrochemical reaction, thus affecting the working ability and efficiency of the stack. In the flow cell disclosed in the prior art, a porous material, such as a graphite felt or a carbon felt, is usually used as an electrode, and the electrolyte flows through the porous electrode and participates in the reaction during operation. Thus, it can be seen that the electrode not only provides an electrochemical reaction site, but also plays a role in distributing the electrolyte. Therefore, in a traditional stack design, it is necessary to balance a thickness of the electrode, an electrochemical activity, a porosity and a conductivity, which is not conducive to maximizing all functions at the same time, so that the stack cannot operate at a high current density.

### SUMMARY OF THE INVENTION

The present invention aims to provide a composite electrode for a flow cell, a flow cell and a stack, which can not only effectively separate an electrochemical reaction site for the electrode from an electrolyte distribution site, but also reduce an internal resistance of the flow cell, thus improving the output power and energy efficiency of the cell.

In order to achieve the above purpose, in a first aspect, the present invention provides a composite electrode for a flow cell, wherein the composite electrode comprises: a distribution layer used for distributing an electrolyte; a reaction layer used for receiving the electrolyte of the distribution layer and providing an electrochemical reaction site for the electrolyte; and a contact layer used for reducing a contact resistance of the distribution layer, so as to reduce an internal resistance of the flow cell.

Preferably, the distribution layer is at least one of a graphite material, a composite graphite material and a metal material with a flow channel structure.

Preferably, the distribution layer is formed by machining, injection molding, extrusion or 3D printing.

Preferably, the distribution layer has a porosity of more than 40% and a thickness of less than 4 mm.

Preferably, the distribution layer has a porosity of more than 50% and a thickness ranging from 1.5 mm to 3 mm.

Preferably, the reaction layer is at least one of a porous carbon fiber material, a powdered carbon material and a porous metal material.

Preferably, the reaction layer has a porosity of more than 60% and a thickness of less than 3 mm.

Preferably, the reaction layer, the distribution layer and the contact layer have a total thickness of less than 5 mm and a compression ratio ranging from 5% to 30% in a free state.

Preferably, the contact layer is at least one of a graphite felt, graphite paper, a flexible graphite material, a flexible composite graphite material and a metal fiber woven material.

Preferably, the contact layer has a thickness of less than 1.5 mm.

Correspondingly, in another aspect, the present invention provides a flow cell, wherein the flow cell comprises: an anode, a cathode, and a separator, wherein at least one of the cathode and the anode is the composite electrode for the flow cell.

Correspondingly, in still another aspect, the present invention provides a stack, wherein the stack comprises: a plurality of the flow cells.

By the above technical solutions, the present invention effectively separates the electrochemical reaction site and the electrolyte distribution site of the composite electrode by providing the distribution layer, the reaction layer and the contact layer in a creative manner, wherein the distribution layer can greatly reduce dead zones and channeling caused by uneven flow distribution, and the contact layer can greatly reduce the internal resistance of the flow cell. Meanwhile, the distribution layer and the reaction layer can be separately and specially designed (for example, a material with a high electrochemical activity is used as the reaction layer, and a material with a characteristic of enhancing fluid flow distribution and an excellent conductivity is used as the distribution layer), thus improving the output power and energy efficiency of a cell or a stack taking the composite electrode as a cathode and/or an anode.

Other features and advantages of the present invention will be described in detail in the following specific embodiments.

### DESCRIPTION OF THE DRAWINGS

FIG. 1 is a schematic diagram of a composite electrode for a flow cell provided by an embodiment of the present invention;

FIG. 2 is a schematic diagram of a flow cell provided by an embodiment of the present invention; and

FIG. 3 is a schematic diagram of a stack provided by an embodiment of the present invention.

### REFERENCE NUMERALS

1 distribution layer
2 reaction layer
3 contact layer
10 composite electrode
20 anode
30 cathode
40 electrode frame
50 separator
60 sealing member
100 flow cell
110 bipolar plate
120 end plate
130 interface
200 stack

### DESCRIPTION OF EXEMPLARY EMBODIMENTS

Specific embodiments of the present invention are described in detail hereinafter with reference to the drawings. It should be understood that the specific embodiments described herein are only used for describing and explaining the present invention, and are not intended to limit the present invention.

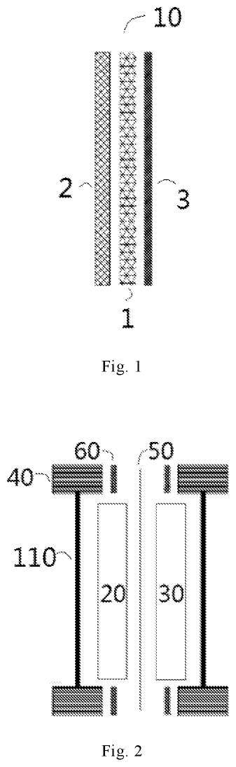

FIG. 1 is a schematic diagram of a composite electrode 10 for a flow cell provided by an embodiment of the present invention. The composite electrode 10 may comprise: a distribution layer 1 used for distributing an electrolyte; a reaction layer 2 used for receiving the electrolyte of the distribution layer and providing an electrochemical reaction site for the electrolyte; and a contact layer 3 used for reducing a contact resistance of the distribution layer, so as to reduce an internal resistance of the flow cell. The contact layer 3 may be a flexible material with a high conductivity, such as flexible graphite.

The distribution layer 1 may be at least one of a graphite material, a composite graphite material and a metal material with a flow channel structure. On the one hand, compared with a graphite felt and a metal fiber woven material, the graphite material, the composite graphite material and the metal material have rigidity and are very easily obtained by machining, thus having a low cost. Specifically, the distribution layer 1 is formed by machining, injection molding, extrusion or 3D printing. On the other hand, the graphite material, the composite graphite material and the metal material are conductive to rapid flow distribution of the electrolyte, so that the electrolyte may be evenly distributed in a short time by a special design (described in the next paragraph), thus avoiding influences of concentration polarization and other factors on an electrochemical reaction.

In order to ensure that the distribution layer 1 has a high conductivity and an excellent fluid distribution characteristic based on easy manufacturing and a low cost, a porosity, a thickness or a fiber diameter of the distribution layer 1 are designed and studied. When the distribution layer 1 has a porosity of more than 40% and a thickness of less than 4 mm, the high conductivity and the excellent fluid distribution characteristic of the distribution layer 1 can be ensured at the same time. In comparison, when the distribution layer 1 has a porosity of more than 50% and a thickness ranging from 1.5 mm to 3 mm, a sheet resistance of the distribution layer 1 can be reduced by more than 20%, and a flow resistance of the electrolyte in the distribution layer 1 can be reduced by more than 20%.

The reaction layer 2 may be at least one of a porous carbon fiber material, a powdered carbon material and a porous metal material. In order to ensure that the reaction layer 2 has a high electrochemical activity, a porosity and a thickness of the reaction layer 2 are designed and studied. When the reaction layer 2 has a porosity of more than 60% and a thickness of less than 3 mm, the high electrochemical activity of the reaction layer 2 can be ensured. In comparison, when the reaction layer 2 has a porosity of 70% and a thickness ranging from 0.5 mm to 2 mm, the sheet resistance can be obviously reduced by more than 20% while the reaction layer 2 has the high electrochemical activity, thus providing an excellent electrode reaction site.

The contact layer 3 may be at least one of a graphite felt, graphite paper, a flexible graphite material, a flexible composite graphite material and a metal fiber woven material. In order to effectively reduce a contact resistance between the distribution layer 1 and a bipolar plate 110, the contact layer may have a thickness of less than 1.5 mm.

In addition, in order to reduce a resistance of the electrode and improve a flow distribution performance of the electrolyte in the electrode, a total thickness and a compression ratio of the distribution layer 1, the reaction layer 2 and the contact layer 3 in a free state are designed and studied. When the reaction layer 2, the distribution layer 1 and the contact layer 3 have a total thickness of less than 5 mm and a compression ratio ranging from 5% to 30% in a free state, concentration polarization in the reaction layer 2 can be reduced while ensuring even flow distribution of the electrolyte. In comparison, when the reaction layer 2, the distribution layer 1 and the contact layer 3 have a total thickness ranging from 2 mm to 4.5 mm and a compression ratio ranging from 10% to 20% in a free state, concentration polarization in the reaction layer 2 can be obviously reduced while ensuring distribution of the electrolyte in the distribution layer 1.

To sum up, the present invention effectively separates the electrochemical reaction site and the electrolyte distribution site of the composite electrode by providing the distribution layer, the reaction layer and the contact layer in a creative manner, wherein the distribution layer can greatly reduce dead zones and channeling caused by uneven flow distribution, and the contact layer can greatly reduce the internal resistance of the flow cell. Meanwhile, the distribution layer and the reaction layer can be separately and specially designed (for example, a material with a high electrochemical activity is used as the reaction layer, and a material with a characteristic of enhancing fluid flow distribution and an excellent conductivity is used as the distribution layer), thus improving the output power and energy efficiency of a cell and a stack taking the composite electrode as a cathode and/or an anode.

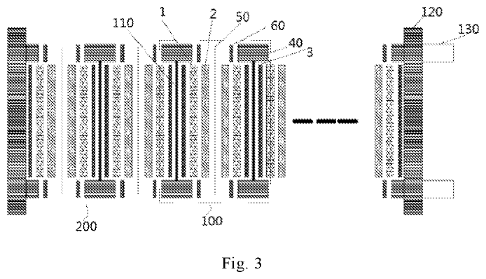

Correspondingly, FIG. 2 is a schematic diagram of a flow cell 100 provided by an embodiment of the present invention. The flow cell 100 may comprise: an anode 20, a cathode 30 and a separator 50, and at least one of the anode 20 and the cathode 30 is the composite electrode 10 for the flow cell. Preferably, the anode 20 and the cathode 30 in the flow cell 100 are both the composite electrode 10, as shown in FIG. 3.

The anode 20 and the cathode 30 may provide anode and cathode reaction sites for the flow cell 100 respectively. An anode reaction may comprise: mutual conversion of pentavalent vanadium ion and tetravalent vanadium ion, mutual conversion of trivalent iron ion and divalent iron ion, and oxidation-reduction reactions of other couples. A cathode reaction may comprise: mutual conversion of trivalent vanadium ion and tetravalent vanadium ion, mutual conversion of trivalent chromium ion and divalent chromium ion, and oxidation-reduction reactions of other couples.

As shown in FIG. 2, the separator 50 may be located in a middle position between the anode 20 and the cathode 30, allow conductive ions of the cathode and anode reactions to pass through, and prevent other ions and solvents from passing through. The above conductive ions may comprise but are not limited to H⁺, Na⁺, K⁺, Li⁺, Cl⁻, OH⁻ and other ions. A material of the separator 50 may be at least one of a sulfonic acid separator material, a polymer porous separator material, an organic/inorganic composite material and an inorganic separator material. As shown in FIG. 3, referring to the separator 50, the reaction layer 2 is located on two sides of the separator 50, the distribution layer 1 is located on an outer side of the reaction layer 2, and the contact layer 3 is located on an outer side of the distribution layer 1.

The flow cell 100 may further comprise: a bipolar plate 110, an electrode frame 40 and a flow pipe (not shown in the drawing). A current lead-out plate (not shown in the drawing) is designed on an outer side of the bipolar plate 110 (the anode 20 and the cathode 30 are both located on an inner side of the bipolar plate 110) to lead out currents of the anode 20 and the cathode 30. The electrode frame 40 is designed at two ends of the bipolar plate 110, as shown in FIG. 2. The flow pipe is used for leading the electrolyte into the electrode frame 40, so that the electrolyte flows into the flow cell 100 through the electrode frame 40, thus charging the cell. Specifically, the electrode frame 40 is provided with a fluid channel, the electrolyte may flow into the distribution layer 1 of the composite electrode 10 through the fluid channel, and the electrolyte is rapidly and evenly distributed in the distribution layer 1 and then transferred from the distribution layer 1 to the reaction layer 2 for the electrochemical reaction. Then, a reaction product is transferred to the distribution layer 1 and flows out of the cell 100 with the electrolyte. The electrode frame 40 may be made of a polymer material, the polymer material may be at least one of polypropylene (PP), polyethylene (PE), polyvinyl chloride (PVC), polyvinylidene fluoride (PVDF) and modified materials thereof, or a material compounded with other polymer fiber.

The flow cell 100 may further comprise a sealing member 60 used for sealing the electrolyte in the interior. A material of the sealing member 60 may be at least one of ethylene propylene diene monomer rubber, nitrile rubber, fluororubber and other materials.

To sum up, the present invention uses the composite electrode as the cathode and/or the anode of the flow cell in a creative manner, and effectively separates the distribution layer from the reaction layer by the composite electrode, wherein the distribution layer can greatly reduce dead zones and channeling caused by uneven flow distribution, and the contact layer can greatly reduce the internal resistance of the flow cell. Meanwhile, the distribution layer and the reaction layer can be separately and specially designed (for example, a material with a high electrochemical activity is used as the reaction layer, and a material with a characteristic of enhancing fluid flow distribution and an excellent conductivity is used as the distribution layer), thus improving the output power and energy efficiency of the flow cell.

Correspondingly, FIG. 3 is a schematic diagram of a stack 200 provided by an embodiment of the present invention. The stack 200 may comprise a plurality of the flow cells 100. The flow cell 100 comprises the anode, the cathode and the separator. The stack 200 further comprises a plurality of the bipolar plates 110 used for connecting the plurality of flow cells in series, as shown in FIG. 3. The electrode frame 40 is designed at two ends of the bipolar plate 110, so that the electrode frame 40 connects each flow cell 100 in parallel in terms of flow of the electrolyte.

As shown in FIG. 3, the stack 200 may further comprise: an end plate 120 used for fixing the plurality of the flow cells 100. The current lead-out plate (not shown in the drawing) is designed between the bipolar plates of the leftmost and rightmost flow cells of the stack 200 and the end plate 120, and used for leading out currents of all cathodes and all anodes. The stack 200 may further comprise: the flow pipe (not shown in the drawing, wherein only an interface 130 of the flow pipe is shown) used for leading the electrolyte into the electrode frame 40 in the flow cell 100, so that the electrolyte flows into the flow cell 100 through the electrode frame 40, thus charging the cell.

The technical solution of the present invention is described by taking the stack 200 shown in FIG. 3 as an example.

The stack 200 is formed by the plurality of flow cells 100 connected in series by the bipolar plates 110, and stacked and fastened into a whole. The electrolyte enters the electrode frame 40 of each flow cell 100 through the flow pipe (not shown in the drawing), and then enters the distribution layer 1 of the composite electrode 10 through the fluid channel of the electrode frame 40. The electrolyte flows rapidly in the distribution layer 1 and is substantively evenly distributed, and then the electrolyte is transferred from the distribution layer 1 to the reaction layer 2 for the electrochemical reaction. A reaction product is transferred to the distribution layer 1 and flows out of the cell with the electrolyte. The flow cell 100 may operate in a charging state or a discharging state, and may be switched between the two states.

Then, the stack 200 formed by the cells 100 with both the cathode and the anode being the composite electrode 10 is explained and described by taking three embodiments and a comparative example as examples.

### Embodiment 1

A structure of a stack 200 composed of flow cells 100 provided in Embodiment 1 is shown in FIG. 3. Specifically, a carbon felt with a thickness of 2 mm is used as a reaction layer 2 of an anode 20 and a cathode 30 of the flow cell 100, a 2 mm-thick composite graphite material with a flow channel structure is used as a distribution layer 1 of the anode 20 and the cathode 30 of the flow cell 100, and flexible graphite with a thickness of 1 mm is used as a contact layer 3 of the anode 20 and the cathode 30. Moreover, the electrode has a size of 200 mm×200 mm. A flat carbon-plastic composite bipolar plate is used as a bipolar plate 110. An electrode frame 40 with a fluid distribution channel and a sealing member 60 made of ethylene propylene diene monomer rubber are used. There are an end plate 120 and an interface 130 on an outer side, and the above components are locked by a bolt and a pressing plate. The carbon felt has a porosity of 90% in Embodiment 1, is an activated carbon felt, and has a fiber diameter of 10 μm. The composite graphite material has a porosity of 50%, and has a sheet resistance of less than 0.1Ω*cm².

### Embodiment 2

A stack 200 provided in Embodiment 2 is different from that provided in Embodiment 1 in that: a carbon felt with a thickness of 1.5 mm is used as a reaction layer 2 of an anode 20 and a cathode 30 of a flow cell 100, and flexible graphite with a thickness of 1 mm is used as a contact layer 3 of the anode 20 and the cathode 30.

### Embodiment 3

A stack 200 provided in Embodiment 3 is different from that provided in Embodiment 1 in that: multi-layer carbon paper with a thickness of 1 mm is used as a reaction layer 2 of an anode 20 and a cathode 30 of a flow cell 100, and flexible graphite with a thickness of 1 mm is used as a contact layer 3 of the anode 20 and the cathode 30. The carbon paper in Embodiment 3 has a porosity of more than 70%.

### Comparative Example

A stack provided in the Comparative Example is different from that provided in Embodiment 1 in that: a carbon felt with a thickness of 5 mm is used as a cathode and an anode of a flow cell. The carbon felt in the Comparative Example has a porosity of 90%, is an activated carbon felt, and has a fiber diameter of 10 μm.

TABLE 1
Experimental results of the embodiments
and the comparative example

| | Flow | Maximum output |
|---|---|---|
| Serial | resistance | power density |
| number | (kPa) | (mW/cm²) |
| Embodiment 1 | 40 | 480 |
| Embodiment 2 | 41 | 510 |
| Embodiment 3 | 43 | 550 |
| Comparative | 52 | 300 |
| Example | | |

It can be seen from the above Table 1 that the introduction of the distribution layer and the contact layer effectively reduces the flow resistance and improves the output power density of the cell, and the combination of the distribution layer, the reaction layer and the contact layer in preferred Embodiments 2 and 3 makes the cell have a better performance.

In the above embodiments, the anode electrolyte has an initial concentration of 0.8 mol L⁻¹ V⁴⁺ (tetravalent vanadium)+0.8 mol L⁻¹ V⁵⁺ (pentavalent vanadium)+3 mol L⁻¹ H₂SO₄, and the cathode electrolyte has an initial concentration of 0.8 mol L⁻¹ V²⁺ (bivalent vanadium)+0.8 mol L⁻¹ V³⁺ (trivalent vanadium)+3 mol L⁻¹ H₂SO₄. In addition, in the above embodiments, output performance tests of the stacks is carried out by a potentiostat.

To sum up, the present invention uses the plurality of flow cells (the composite electrode is used as the cathode and/or the anode of the flow cell) to form the stack in a creative manner, and effectively separates the distribution layer from the reaction layer by the composite electrode, wherein the distribution layer can greatly reduce dead zones and channeling caused by uneven flow distribution, and the contact layer can greatly reduce the internal resistance of the flow cell. Meanwhile, the distribution layer and the reaction layer can be separately and specially designed (for example, a material with a high electrochemical activity is used as the reaction layer, and a material with a characteristic of enhancing fluid flow distribution and an excellent conductivity is used as the distribution layer), thus improving the output power and energy efficiency of the stack.

The preferred embodiments of the present invention are described in detail above with reference to the drawings, but the present invention is not limited to the specific details in the above embodiments. Within the technical concept of the present invention, the technical solutions of the present invention may have many simple modifications, and these simple modifications all belong to the scope of protection of the present invention.

In addition, it should be noted that the specific technical features described in the above specific embodiments can be combined in any suitable way without contradiction. In order to avoid unnecessary repetition, various possible combinations will not be explained separately in the present invention.

In addition, different embodiments of the present invention can be combined at will, as long as the combination does not violate the idea of the present invention, and the combination should also be regarded as the content disclosed by the present invention.

1. A composite electrode for a flow cell, wherein the composite electrode comprises:
a distribution layer used for distributing an electrolyte;
a reaction layer used for receiving the electrolyte of the distribution layer and providing an electrochemical reaction site for the electrolyte; and
a contact layer used for reducing a contact resistance of the distribution layer, so as to reduce an internal resistance of the flow cell.

2. The composite electrode for the flow cell according to claim 1, wherein the distribution layer is at least one of a graphite material, a composite graphite material and a metal material with a flow channel structure.

3. The composite electrode for the flow cell according to claim 1, wherein the distribution layer is formed by machining, injection molding, extrusion or 3D printing.

4. The composite electrode for the flow cell according to claim 1, wherein the distribution layer has a porosity of more than 40% and a thickness of less than 4 mm.

5. The composite electrode for the flow cell according to claim 1, wherein the distribution layer has a porosity of more than 50% and a thickness ranging from 1.5 mm to 3 mm.

6. The composite electrode for the flow cell according to claim 1, wherein the reaction layer is at least one of a graphite felt, a carbon felt material, a porous carbon fiber material, a powdered carbon material, a porous metal material and a metal fiber woven material.

7. The composite electrode for the flow cell according to claim 1, wherein the reaction layer has a porosity of more than 60% and a thickness of less than 3 mm.

8. The composite electrode for the flow cell according to claim 1, wherein the reaction layer, the distribution layer and the contact layer have a total thickness of less than 5 mm and a compression ratio ranging from 5% to 30% in a free state.

9. The composite electrode for the flow cell according to claim 1, wherein the contact layer is at least one of a graphite felt, graphite paper, a flexible graphite material, a flexible composite graphite material and a metal fiber woven material.

10. The composite electrode for the flow cell according to claim 1, wherein the contact layer has a thickness of less than 1.5 mm.

11. A flow cell, comprising:
an anode,
a cathode, and
a separator,
wherein at least one of the cathode and the anode is a composite electrode for the flow cell and comprises:
a distribution layer used for distributing an electrolyte;
a reaction layer used for receiving the electrolyte of the distribution layer and providing an electrochemical reaction site for the electrolyte; and
a contact layer used for reducing a contact resistance of the distribution layer, so as to reduce an internal resistance of the flow cell.

12. The flow cell according to claim 11, wherein the distribution layer is at least one of a graphite material, a composite graphite material and a metal material with a flow channel structure.

13. The flow cell according to claim 11, wherein the distribution layer is formed by machining, injection molding, extrusion or 3D printing.

14. The flow cell according to claim 11, wherein the distribution layer has a porosity of more than 40% and a thickness of less than 4 mm.

15. The flow cell according to claim 11, wherein the distribution layer has a porosity of more than 50% and a thickness ranging from 1.5 mm to 3 mm.

16. The flow cell according to claim 11, wherein the reaction layer is at least one of a graphite felt, a carbon felt material, a porous carbon fiber material, a powdered carbon material, a porous metal material and a metal fiber woven material.

17. The flow cell according to claim 11, wherein the reaction layer has a porosity of more than 60% and a thickness of less than 3 mm.

18. The flow cell according to claim 11, wherein the reaction layer, the distribution layer and the contact layer have a total thickness of less than 5 mm and a compression ratio ranging from 5% to 30% in a free state.

19. The flow cell according to claim 11, wherein the contact layer is at least one of a graphite felt, graphite paper, a flexible graphite material, a flexible composite graphite material and a metal fiber woven material.

20. A stack, comprising:
a plurality of flow cells,
wherein each of the plurality of flow cells comprises:
an anode,
a cathode, and
a separator,
wherein at least one of the cathode and the anode comprises:
a distribution layer used for distributing an electrolyte,
a reaction layer used for receiving the electrolyte of the distribution layer and providing an electrochemical reaction site for the electrolyte, and
a contact layer used for reducing a contact resistance of the distribution layer, so as to reduce an internal resistance of the flow cell.
